(19) United States
(12) Patent Application Publication
(10) Pub. No.: US 2019/0202613 A1
(43) Pub. Date: Jul. 4, 2019

(54) TUBULAR CASING CONTAINER AND MANUFACTURING METHOD FOR TUBULAR CASING CONTAINER

(71) Applicant: FUJI TOKUSHU SHIGYO CO., LTD., Aichi-ken (JP)

(72) Inventor: Satoshi FUJIOKA, Aichi-ken (JP)

(21) Appl. No.: 15/934,171

(22) Filed: Mar. 23, 2018

(30) Foreign Application Priority Data
Dec. 30, 2017 (JP) 2017-255276

(51) Int. Cl. B65D 65/18; B65D 33/04; B65D 65/14; B65D 65/24; B29C 65/48; B41M 1/26

(52) U.S. Cl. CPC B65D 65/18; B65D 33/04; B65D 65/14; A22C 2013/0079; B29C 65/4815; B29C 65/482; B41M 1/26; B65D 65/24

(57) ABSTRACT

A tubular casing has a package design (la) printed on an original fabric film (1) with transparent no-print zones (2, 3) formed along left and right end edges (2a, 3a). Best before date characters (4) are inkjet printed on the no-print zone (2). The fabric film (1) is bent to place the no-print zone (2) with printed characters on a lower side and form the fabric film (1) in a cylindrical shape. A heat seal portion (H) is formed including the date characters (4), in the no-print zone (2) located on the lower side. The heat seal portion (H) is formed up to the end edge (2a) of the no-print zone (2) and a no-heat seal portion (S) is formed on the end edge (3a) side of the no-print zone (3) located on an upper side to form a casing portion. Both ends of the casing portion are sealed.

### BACKGROUND OF THE INVENTION

### Field of the Invention

The present invention relates to a tubular casing container that stores food and a manufacturing method for the tubular casing container and, more specifically, to a tubular casing container on which a transparent film portion is superimposed on an upper side and heat-sealed to, while allowing characters of a best before date and the like to be seen through from the outside, prevent the printed characters from being rubbed off and prevent ink used for the printing from adhering to food and a manufacturing method for the tubular casing container.

### Description of the Related Art

In a packing bag for storing and sealing food, when it is attempted to display a best before date and the like of the stored food, in general, the best before date and the like are printed on the outer surface of a packing film.

However, in this case, ink for printing character information adheres to the outside of the packing film. Therefore, the ink is rubbed off by a touch of a human hand, erased by water, or melted by heat. As a result of this, characters cannot be distinguished.

During transportation or during display of a commodity, ink and the like of other commodities adhere to the commodity to deteriorate the value of the commodity.

Further, the character information printed on the outer surface of the packing film can be easily falsified. Therefore, there is also a concern that illegal acts of falsifying the best before date are rampant.

Therefore, Japanese Patent Laid-Open No. 2005-162279 (Patent Literature 1) proposes a packing bag in which, by performing a heat seal to match the positions of display marks and the positions of the heat seal using a plastic film for the packing bag formed by printing, on a seal surface side of a belt-like plastic film, the display marks at a fixed interval in a longitudinal direction and in a part equivalent to a heat seal portion after packing bag formation, even if printing of the surface marks is performed by inkjet print or transfer print in which ink is used, since a printing surface is located on the inner side of the heat seal portion, printed characters are not blurred and peeled by rubbing or the like of packing bags and falsification of the display marks is impossible.

However, as described in Patent Literature 1, when the display marks are printed in advance on the seal surface side of the plastic film and subsequently the heat seal is only performed to match the positions of the display marks and the positions of the seal portions after the packing bag formation, the position of the printed portion and the position of the food are close. Therefore, when a defect such as a break or a pinhole occurs in the packing bag because of a shock or a bend, the ink is likely to easily come into contact with the food.

It is impossible to accurately predict the number of commodities to be supplied as that always changes according to demand. A film loss occurs when a best before date and the like are printed on a packing film in advance.

Even with the invention described in Patent Literature 1, the best before date and the like have to be printed before the food is actually filled. The ink and the food come close to each other before the ink is completely dried. Therefore, the ink easily comes into direct contact with the food. In addition, the food is easily affected by toxic substances (an organic solvent, etc.) contained in the ink.

### SUMMARY OF THE INVENTION

The present invention has been proposed in view of such problems, and an object of the present invention is to provide a tubular casing container that, while allowing characters of a best before date and the like printed on a packing bag to be seen through from the outside, prevent the printed characters from being rubbed off by contact with the outside and prevent ink in a printed portion from directly and indirectly coming into contact with a filled food and a manufacturing method for the tubular casing container.

In order to achieve the object, according to the present invention, there is provided a tubular casing container, in which, when a package design is printed on a flat original fabric film, transparent no-print zones are formed along both left and right end edges in the original fabric film, a best before date and the like are printed on a surface of the no-print zone by an inkjet method, the original fabric film is circularly bent to place the no-print zone, on which the best before date and the like are printed, on a lower side and form a cylindrical casing portion, a heat sealing of a superimposed portion is performed in a portion of the best before date and the like, in the no-print zone located on the lower side in a portion of the heat seal, the heat seal portion is formed up to the end edge of the no-print zone and a no-heat seal portion is formed on the end edge side of the no-print zone located on an upper side, and both ends of the casing portion are sealed by clips.

In the tubular casing container according to another aspect of the present invention, both the ends of the casing portion of the tubular casing container may be welded by a heat sealing method instead of the clips.

According to another aspect of the present invention, there is provided a manufacturing method for a tubular casing container including: printing a package design on an original fabric film and forming transparent no-print zones along both left and right end edges; subsequently printing a best before date and the like on a surface of the no-print zone of the original fabric film with an inkjet method; subsequently circularly bending the original fabric film to place the no-print zone, on which the best before date and the like are printed, on a lower side and forming a cylindrical casing portion; subsequently performing a heat seal of a superimposed portion in a portion of the best before date and the like and, in the no-print zone located on the lower side in a portion of the heat seal, forming the heat seal portion up to the end edge of the no-print zone and forming a no-heat seal portion on the end edge side of the no-print zone located on an upper side; subsequently filling food in the cylindrical casing portion; and subsequently sealing both ends of the cylindrical casing portion with clips or a heat seal method and cutting outsides of the clips.

As explained above, according to the present invention, by printing the best before date and the like on the inner side of the heat seal surface, in which the transparent no-print zone is placed on the upper side, using inkjet ink, it is possible to prevent characters of the best before date and the like from being erased or to be affected so as to no longer be distinguished. It is possible to allow the characters of the best before date and the like to be seen through from the outside.

A portion of the film other than the heat seal portion can be secured as a printing region. Therefore, it is possible to realize package manufacturing having excellent designability making use of this wide printing region.

Further, by providing a no-print buffer portion between the printing portion of the best before date and the like and the food, it is possible to prevent the ink from coming into contact with the food and prevent the food from being affected by toxic substances contained in the ink even if the food does not directly come into contact with the ink.

### BRIEF DESCRIPTION OF THE DRAWINGS

FIG. 1 is an explanatory perspective view of an original fabric film on which design of a label or the like is printed and transparent no-print zones are formed along both left and right end edges;

FIG. 2 is an explanatory perspective view of the original fabric film in a circularly bent state showing a state in which a heat seal is performed to place a printing portion of a best before date and the like on a lower side and the original fabric film is formed in a cylindrical shape;

FIG. 3 is a sectional view of a heat seal portion showing a state before the heat seal;

FIG. 4 is a sectional view of the heat seal portion showing a state after the heat seal;

FIG. 5 is an explanatory perspective view of a tubular casing container; and

FIG. 6 is a flowchart for explaining a manufacturing process for the tubular casing container.

### DETAILED DESCRIPTION OF THE PREFERRED EMBODIMENTS

### First Embodiment

An embodiment of the present invention is explained in detail below with reference to the drawings.

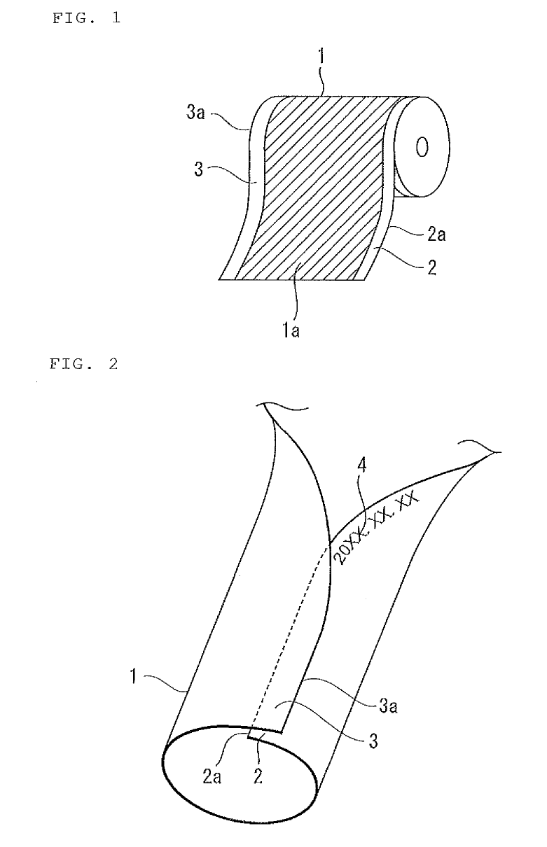

In FIG. 1, reference numeral 1 denotes an original fabric film. A package design 1a is printed in the center of the original fabric film 1. Transparent no-print zones 2 and 3 are formed along both left and right end edges 2a and 3a.

In FIG. 2, reference numeral 4 denotes a best before date and the like (best before date characters) printed on the no-print zone 2 by an inkjet method. The original fabric film 1 is circularly bent and formed in a cylindrical shape to place the no-print zone 2, on which the best before date and the like 4 are printed, on a lower side.

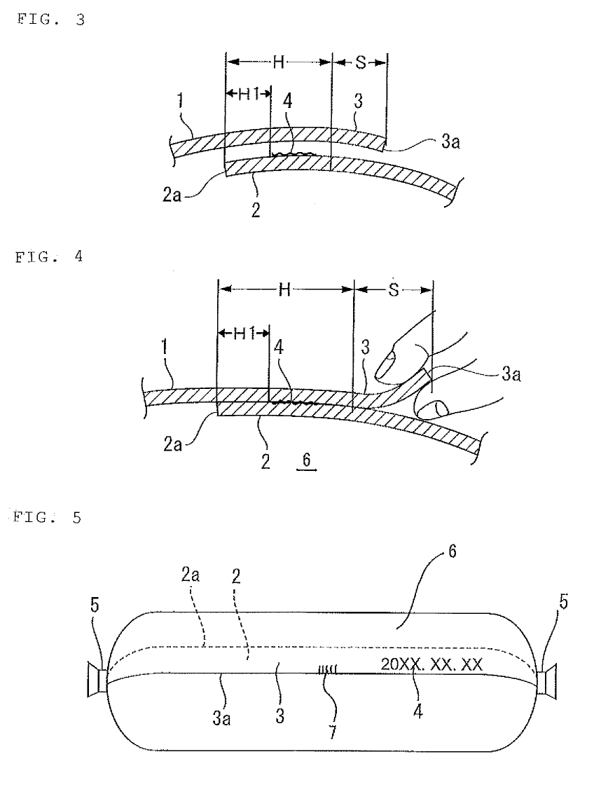

FIG. 3 is a sectional view of a heat seal portion showing a state before heat seal is performed. FIG. 4 is a sectional view of the heat seal portion showing a state after the heat seal is performed. The no-print zone 2 is placed on the lower side as explained above, the no-print zone 3 is placed on an upper side, and the heat seal is performed in an overlapping position of the best before date and the like 4, which is printed in the no-print zone 2, and the no-print zone 3 to form a heat seal portion H.

In the no-print zone 2, the heat seal portion H is formed up to the end edge 2a of the no-print zone 2. A noninterference portion H1 of ink and a food 6 may be formed between the best before date and the like 4 and the end edge 2a.

That is, the noninterference portion H1 is located between the best before date and the like 4 and the food 6. Therefore, even when some type of trouble or the like occurs, it is possible to prevent the ink of the best before date and the like 4 from directly coming into contact with the food 6. Even if some type of trouble or the like does not occur, substances harmful for a human body and the food 6 are separated by adhesion to achieve an effect of a so-called noninterference zone H1.

It is noted that the width of the noninterference portion H1 can be changed according to the width of the no-print zone 2 and a position where the heat seal is performed. Therefore, it goes without saying that the noninterference portion H1 is desirably formed to be wide in order to prevent contact of the ink and the food 6.

As opposed to the no-print zone 2 in which the heat seal portion is formed up to the end edge 2a, in the no-print zone 3, the heat sealing is not performed up to the end edge 3a of the no-print zone 3 and a no-heat seal portion S is formed.

The no-heat seal portion S is exposed to the outside of a casing and formed to be pinched by fingers. Therefore, an I notch 7 or a V notch, a scratch, or the like may be formed as a tearing start portion to facilitate an opening of a container.

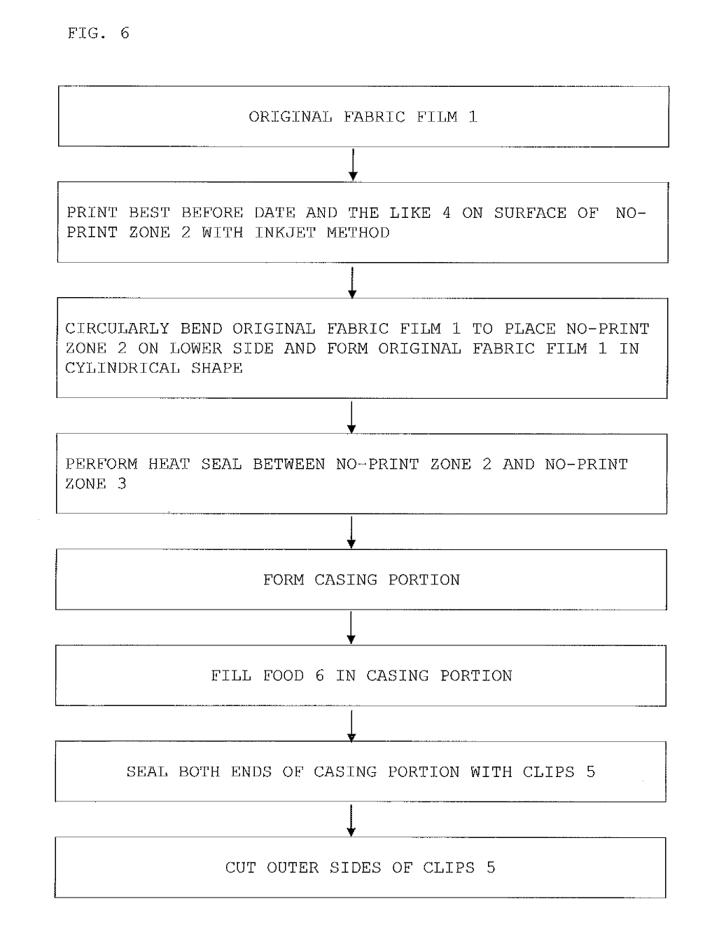

In FIG. 5, reference numeral 5 denotes clips. Both ends of a casing portion formed in a cylindrical shape are sealed. This may be by applying the clips 5 to seal and complete a tubular casing container.

### Second Embodiment

When both the ends of the casing portion are sealed by a heat sealing method instead of the clips 5, it is also possible to keep sealing performance of the tubular casing container high.

### Third Embodiment

FIG. 6 is a flowchart for explaining a manufacturing process for the tubular casing container according to the present invention. The original fabric film 1, on which the package design 1a is printed and the transparent no-print zones 2 and 3 are formed along both the left and right end edges, is let out from a roll. The best before date and the like 4 are printed on the surface of the no-print zone 2 by an inkjet method using an inkjet printer.

Subsequently, the original fabric film 1 is circularly bent to place the no-print zone 2, on which the best before date and the like 4 are printed, on a lower side to form a food filling portion (a casing portion) using a bag making machine.

Subsequently, the heat sealing is performed and a heat seal is formed in a printing portion of the best before date and the like 4 using the bag making machine. On the no-print zone 2 side located on the lower side in the heat seal portion H, the heat sealing is performed and a heat seal is formed up to the end edge 2a of the no-print zone 2 to form a noninterference portion H1. The no-heat seal portion S is formed on the end edge 3a side of the no-print zone 3 located on the upper side.

Subsequently, food is filled in the cylindrical casing portion using a filling machine. Both ends of the cylindrical casing portion are sealed. The sealing may be by applying the clips 5 or the like. Outer sides of the clips 5 are cut. In the alternative, the ends of the cylindrical casing portion are sealed by heat sealing to provide a heat seal at each end. Outer sides beyond the heat seals at each of the ends may be cut.

While specific embodiments of the invention have been shown and described in detail to illustrate the application of the principles of the invention, it will be understood that the invention may be embodied otherwise without departing from such principles.

What is claimed is:

1. A tubular casing container comprising:
a flat original fabric film with transparent no-print zones formed along both left and right end edges in the original fabric film;
a package design printed on the flat original fabric film between the left and right end edges;
best before date characters comprising ink printed on a surface of the no-print zone by an inkjet method, wherein the original fabric film is circularly bent to provide a superimposed portion with the no-print zone, on which the best before date characters are printed, on a lower side and with the other no-print zone at an upper side to form a cylindrical casing portion;
a heat seal forming a heat seal portion at the superimposed portion comprised of a portion with the printed best before date characters in the no-print zone located on the lower side in a portion of the heat seal portion and a portion of the other no-print zone at the upper side, wherein the heat seal portion extends up to an end edge of the no-print zone located on the lower side;
a no-heat seal portion formed on an end edge side of the no-print zone located on the upper side, wherein the heat seal portion extends from the end edge of the no-print zone located on the lower side to the no-heat seal portion; and
an end seal at each of two ends of the casing portion.

2. The tubular casing container according to claim 1, wherein each end seal is formed by clips that seal each of the two ends of the casing portion.

3. The tubular casing container according to claim 1, wherein each end seal comprises a heat seal weld formed by heat sealing each of the two ends of the casing portion.

4. The tubular casing container according to claim 1, wherein the heat seal portion comprises a noninterference portion extending from the end edge of the no-print zone located on the lower side to the ink of the best before date characters.

5. The tubular casing container according to claim 4, wherein a food filling is disposed in the casing portion.

6. The tubular casing container according to claim 5, wherein the noninterference portion is located between the ink of the best before date and the food filling, whereby ink is prevented from directly coming into contact with the food filling.

7. A manufacturing method for forming a tubular casing container, the method comprising the steps of:
printing a package design on an original fabric film and forming transparent no-print zones along both left and right end edges of the original fabric film;
subsequent to the step of printing a package design, printing best before date characters on a surface of the no-print zone of the original fabric film with an inkjet method;
subsequent to the step of printing best before date characters, circularly bending the original fabric film to place the no-print zone, on which the best before date characters are printed, on a lower side and the other no-print zone on an upper side to form a superimposed portion and to form a cylindrical casing portion;
subsequent to the step of circularly bending the original fabric film, performing heat sealing of some of the superimposed portion to form a heat seal portion comprised of a portion with the best before date characters in the no-print zone located on the lower side, the heat seal portion extending up to an end edge of the no-print zone of the lower side and forming an upper side no-heat seal portion extending from the heat seal portion to an end edge side of the no-print zone located on the upper side;
subsequent to the step of performing heat sealing, filling food in the cylindrical casing portion;
subsequent to the step of filling food in the cylindrical casing portion, sealing both ends of the cylindrical casing portion with clips or by heat sealing to form sealed ends; and
subsequent to the step of sealing both ends, cutting off outsides of the sealed ends.

8. The manufacturing method according to claim 7, wherein:
the heat seal portion comprises a noninterference portion extending from the end edge of the no-print zone located on the lower side and the ink of the best before date characters; and
the noninterference portion is located between the ink of the best before date and the food, whereby ink is prevented from directly coming into contact with during the step of filling food in the cylindrical casing portion.
